(19) United States
(12) Patent Application Publication
(10) Pub. No.: US 2026/0260504 A1
(43) Pub. Date: Sep. 3, 2026

(54) METHOD, APPARATUS, DEVICE, MEDIUM AND PRODUCT OF VIDEO ANNOTATION

(71) Applicant: Beijing Zitiao Network Technology Co., Ltd., Haidian District, Beijing (CN)

(72) Inventors: Pengxiang Yan, Beijing (CN); Xiaohe Zhang, Beijing (CN); Sining Zhu, Beijing (CN); Hao Liu, Beijing (CN); Qing Zhao, Beijing (CN); Jie Wu, Beijing (CN); Yitong Wang, Beijing (CN)

(21) Appl. No.: 19/130,265

(22) PCT Filed: Nov. 10, 2023
(86) PCT No.: PCT/CN2023/131040

§ 371 Date: May 15, 2025

(30) Foreign Application Priority Data
Nov. 15, 2022 (CN) 202211430304.2

(51) Int. Cl. G06V 20/70; G06V 20/40

(52) U.S. Cl. CPC G06V 20/70; G06V 20/46

(57) ABSTRACT

The embodiments of the disclosure provide a method, apparatus, device, medium and product of video annotation. The method of video annotation may include: in response to a video annotation request, determining a first sub-segment among sub-segments to be annotated in a video to be annotated; in response to an annotation operation performed by a user for a start frame of the first sub-segment, obtaining a start frame annotation result of the start frame; in response to an annotation request for an end frame of the first sub-segment, generating an end frame annotation result of the end frame; in response to an annotation request for an intermediate frame(s) of the first sub-segment, generating an intermediate frame annotation result of the intermediate frame; and displaying a video annotation result of the video to be annotated in a video annotation page based on annotation results of respective image frames of the first sub-segment.

This application claims the priority of Chinese Patent Application No. 2022114303042, filed Nov. 15, 2022, entitled “Method, Apparatus, Device, Medium and Product of Video Annotation”, the entire contents of which are incorporated herein by reference.

### FIELD

The embodiment of the present disclosure relates to the technical field of computers, in particular to a method, apparatus, device, medium and product of video annotation.

### BACKGROUND

Video segmentation annotation is generally performed by traditional picture segmentation, generally, video frames are extracted according to a certain sampling frequency, and video obtained by sampling is distributed to the annotation personnel for manual annotation. The annotation personnel may complete the manual annotation in a manner such as area selection and graphic rendering. However, the manner of only adopting manual annotation is relatively limited, and annotation efficiency is low.

### SUMMARY

The embodiment of the present disclosure provides a method, apparatus, device, medium and product of video annotation, so as to overcome the problems of relatively limited manual annotation manner and low annotation efficiency.

According to a first aspect, an embodiment of the present disclosure provides a method of video annotation, comprising:
in response to a video annotation request, determining a first sub-segment among sub-segments to be annotated in a video to be annotated;
in response to an annotation operation performed by a user for a start frame of the first sub-segment, obtaining a start frame annotation result of the start frame;
in response to an annotation request for an end frame of the first sub-segment, generating an end frame annotation result of the end frame;
in response to an annotation request for an intermediate frame(s) of the first sub-segment, generating an intermediate frame annotation result of the intermediate frame;
displaying a video annotation result of the video to be annotated in a video annotation page based on annotation results of respective image frames of the first sub-segment.

According to a second aspect, an embodiment of the present disclosure provides an apparatus for video annotation, comprising:
a first response unit, configured to determine, in response to a video annotation request, a first sub-segment among sub-segments to be annotated in a video to be annotated;
a second response unit, configured to obtain, in response to an annotation operation performed by a user for a start frame of the first sub-segment, a start frame annotation result of the start frame;
a third response unit, configured to generate, in response to an annotation request for an end frame of the first sub-segment, an end frame annotation result of the end frame;
a fourth response unit, configured to generate, in response to the annotation request for an intermediate frame(s) of the first sub-segment, an intermediate frame annotation result of the intermediate frame;
a first display unit, configured to display a video annotation result of the video to be annotated in a video annotation page based on annotation results of respective image frames of the first sub-segment.

According to a third aspect, an embodiment of the present disclosure provides an electronic device, comprising a processor, a memory, and an output device;
the memory storing computer-executable instructions;
the processor executes the computer-executable instructions stored in the memory, such that the processor is configured with the method of video annotation according to the first aspect and various possible designs of the first aspect, and the output device is configured to output the video annotation page.

According to a fourth aspect, an embodiment of the present disclosure provides a computer-readable storage medium, wherein the computer-readable storage medium stores computer-executable instructions, the computer-executable instructions, when executed by a processor, implement the method of video annotation according to the first aspect and various possible designs of the first aspect.

According to a fifth aspect, an embodiment of the present disclosure provides a computer program product, comprising a computer program, wherein the computer program is executed by a processor to be configured with the method of video annotation according to the first aspect and various possible designs of the first aspect.

According to the technical solution provided in this embodiment, in response to the video annotation request, the first sub-segment among the sub-segments to be annotated in the video to be annotated may be determined, and the annotation for the first sub-segment is initiated. At this time, in response to an annotation operation performed by a user for a start frame of the first sub-segment, a start frame annotation result of the start frame may be obtained. Then, in response to an annotation request for an end frame of the first sub-segment, an end frame annotation result of the end frame may be generated, and in response to an annotation request for an intermediate frame(s) of the first sub-segment, an intermediate frame annotation result of the intermediate frame may be generated. The sequence annotation of the respective image frame in the first sub-segment is achieved by manually annotating the start frame, automatically annotating the end frame, and the intermediate frame. By automatically annotating the end frame and the middle frame, the annotation manner of the image is increased, the annotation difficulty of the image is effectively reduced, and the annotation efficiency is improved.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is an application example diagram of a method of video annotation according to an embodiment of the present disclosure;

FIG. 2 is a flowchart of a method of video annotation according to an embodiment of the present disclosure;

FIG. 3 is a flowchart of still another embodiment of a method of video annotation according to an embodiment of the present disclosure;

FIG. 4 is an example diagram of a video annotation page according to an embodiment of the present disclosure;

FIG. 5 is an example diagram of a task establishment page according to an embodiment of the present disclosure;

FIG. 6 is a flowchart of still another embodiment of a method of video annotation according to an embodiment of the present disclosure;

FIG. 7 is a schematic structural diagram of an embodiment of an apparatus for video annotation according to an embodiment of the present disclosure;

FIG. 8 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. All other embodiments obtained by those skilled in the art based on the embodiments of the present disclosure without creative efforts shall fall within the scope of the present disclosure.

According to the technical scheme, the method may be applied to a video annotation scene, the image to be annotated is manually annotated according to the start frame, the end frame and the intermediate frame are automatically annotated, the video to be annotated is annotated with a combination manual annotation and automatic annotation in a segmented manner, the annotation efficiency of the video to be annotated is increased, and the annotation efficiency and accuracy of the video are improved.

In the related art, in a video segmentation scenario, a video segmentation model needs to be trained by using an annotated video. Annotation of videos is generally done manually. The annotation of videos is generally distributed to annotation personnel for manual annotation. In practical applications, after the video frames are sent to the plurality of annotation personnels, the annotation personnels may complete the annotation in a manner such as curve drawing, object annotation, setting of the object type or name and etc. However, the above annotation method is mainly completed by manual annotation, and the annotation manner is too limited, resulting in lower annotation efficiency of the image.

The present disclosure relates to the technical field of image processing, artificial intelligence and the like, in particular to a method, apparatus, device, medium and product of video annotation.

In order to solve the above technical problem, in the technical solution of the present disclosure, in response to the video annotation request, the first sub-segment among the sub-segments to be annotated in the video to be annotated may be determined from the video to be annotated, and in response to an annotation operation performed by a user for a start frame of the first sub-segment, a start frame annotation result of the start frame may be obtained, and in response to an annotation request for an end frame of the first sub-segment, an end frame annotation result of the end frame may be generated, at the same time, in response to an annotation request for an intermediate frame(s) of the first sub-segment, an intermediate frame annotation result of the intermediate frame may be generated. The start frame annotation result is manually obtained by sampling, the annotation result of the end frame and the intermediate frame is automatically generated, manual annotation is reduced, and the annotation efficiency of the image frame is improved. In addition, through the annotation operation of the start frame, the annotation request of the end frame and the intermediate frame, the interaction annotation with the user is realized, and the effectiveness of annotation interaction is improved. According to the annotation result of respective image frame of the first sub-segment, the video annotation result of the video to be annotated may be displayed on the video annotation page, to implement visualization of the annotation process. According to the annotation method provided by the scheme, the annotation manner of the image is increased, the annotation difficulty of the image is effectively reduced, the annotation efficiency is improved, meanwhile, annotation visual interaction is provided, and the annotation effect and precision are improved.

The technical solutions of the present disclosure and the technical solutions of the present disclosure will be described in detail below with reference to specific embodiments. The following specific embodiments may be combined with each other, and the same or similar concepts or processes may be omitted in some embodiments. Embodiments of the present disclosure will be described in detail below with reference to the accompanying drawings.

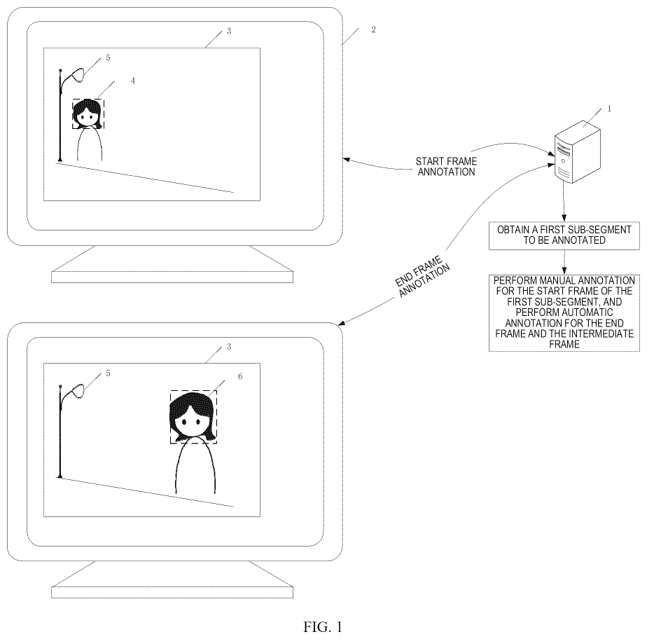

As shown in FIG. 1, FIG. 1 is an application example diagram of a method of video annotation according to an embodiment of the present disclosure, and the method of video annotation may be configured in the electronic device 1. The electronic device 1 may correspond to the display apparatus 2. The display apparatus 2 may be configured to display a video annotation interface 3.

Optionally, the video annotation request may be triggered by the user in an interactive manner, the electronic device 1 may detect the video annotation request, and obtain the video to be annotated corresponding to the video annotation request. The electronic device 1 may further determine a first sub-segment among the sub-segments to be annotated from the video to be annotated. The electronic device 1 may start the annotation from the start frame, and perform the annotation operation with the user to obtain the start frame annotation result. After obtaining the start frame, the start frame may be annotated to obtain the start frame annotation result 4, for example, the annotated face annotation frame 4 in the image to be annotated shown in the display apparatus 2, and for other areas in the image, for example, the area where the street lamp 5 is located may not be annotated. Then, the start frame may be switched to the end frame for annotation, and the end frame annotation result of the end frame is automatically generated, for example, the face annotation frame 6 shown in FIG. 1. Then, the end frame may be switched to the intermediate frame for annotation, and the intermediate frame annotation result of the intermediate frame is also automatically generated. Through the strategy of manually annotating the start frame, and automatically annotating the end frame and the intermediate frame, the annotation efficiency of the video can be improved. The annotation object of the intermediate frame may be the same as the annotation object of the start frame and the annotation object of the end frame, for example, all performing the annotation for the face.

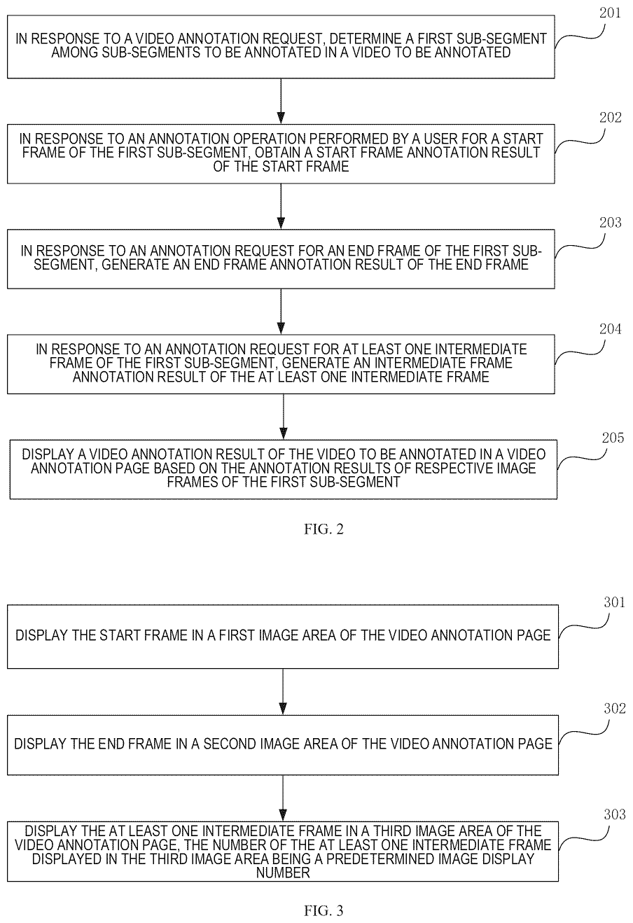

As shown in FIG. 2, FIG. 2 is a flowchart of an embodiment of a method of video annotation according to an embodiment of the present disclosure, where the method may be configured as an apparatus for video annotation, and the apparatus for video annotation may be located in an electronic device. The method of video annotation may include the following steps:

201: in response to a video annotation request, determine a first sub-segment among sub-segments to be annotated in a video to be annotated.

Optionally, the video annotation request may be an access method generated by a user triggered image annotation operation. The video annotation request may specify a video to be annotated. Specifically, the video annotation request may be an annotation link initiated by the user for the video to be annotated, for example, a URL link. The video annotation request may include a storage address of the video to be annotated. The video to be annotated may be loaded according to the storage address of the video to be annotated.

In order to accurately annotate the video to be annotated, the sub-segment to be annotated may be obtained from the video to be annotated as the first sub-segment, and the first sub-segment is annotated.

For example, the video to be annotated may include at least one video sub-segment to be annotated. The at least one video sub-segment may be obtained by performing video segmentation on the video to be annotated. The first sub-segment may be a first video sub-segment in the at least one video sub-segment.

202: in response to an annotation operation performed by a user for a start frame of the first sub-segment, obtain a start frame annotation result of the start frame.

Optionally, the image frame in the first sub-segment may be annotated with manual annotation or automatic annotation. The start frame may be manually annotated in a manner of performing an annotation operation by the user. The end frame and the intermediate frame may be automatically annotated in response to the annotation request. The annotation operation may be operations such as an area selection and an annotation setting performed manually for the image to be annotated. The start frame annotation result of the start frame is obtained through detecting a manually performed annotation operation.

203: in response to an annotation request for an end frame of the first sub-segment, generate an end frame annotation result of the end frame.

In the process of generating the end frame annotation result, the unannotated end frame may be automatically annotated through the start frame annotation result of the annotated start frame to obtain the end frame annotation result of the end frame. Through the automatic annotation, the end frame annotation efficiency and accuracy are improved.

Optionally, after generating the end frame annotation result of the end frame, the method may further include: displaying the end frame and the end frame annotation result in the video annotation page. In addition, the method may further include: in response to a modification operation performed for the end frame annotation result, obtaining an updated end frame annotation result. The end frame annotation result may be an annotation result confirmed by the user, and the accuracy and precision of the end frame annotation result are improved.

Optionally, the annotation request of the end frame may be generated by the user triggering the annotation control, or may be automatically generated by the electronic device at the end of the annotation of the previous one image frame.

204: in response to an annotation request for an intermediate frame(s) of the first sub-segment, generate an intermediate frame annotation result of the intermediate frame.

In the generation process of the intermediate frame annotation result, the unannotated intermediate frame may be automatically annotated through the start frame annotation result of the annotated start frame and the end frame annotation result of the end frame, to obtain the intermediate frame annotation result of the intermediate frame. Through the automatic annotation, the annotation efficiency and accuracy of the intermediate frames are improved.

For example, a semi-supervised machine learning model, a deep neural network, or the like may be used to calculate the model, and the end frame or the intermediate frame may be automatically annotated in combination with the annotation result of the start frame to achieve automatic normal of the annotation result. For the algorithm of automatically learning the annotation result of the image frame, reference may be made to the implementation of the related technology, which is not described herein again.

The intermediate frame may be an image frame between the start frame and the end frame, and each intermediate frame may perform the step of generating an intermediate frame annotation result of the intermediate frame in response to the annotation request for the intermediate frame of the first sub-segment. The intermediate frames between the start frame and the end frame may include a plurality of intermediate frames, and the respective intermediate frames may be sequentially annotated according to a sequence of respective intermediate frames in the sub-segment, to obtain an intermediate frame annotation result of the respective intermediate frame.

Optionally, the annotation request of the intermediate frame may be generated by the user triggering the annotation control, or may be automatically generated by the electronic device at the end of the annotation of one previous image frame.

205: display a video annotation result of the video to be annotated in a video annotation page based on annotation results of respective image frames of the first sub-segment.

Optionally, the annotation result of the respective image frame of the first sub-segment may be displayed on the video annotation page. The annotation result of each image frame may be displayed when the annotation of each image frame is completed.

The video annotation result of the video to be annotated may include: an annotation result of the image frame of the respective video sub-segment.

In the technical solution of the present disclosure, in response to the video annotation request, the first sub-segment among the sub-segments to be annotated in the video to be annotated may be determined from the video to be annotated, and in response to an annotation operation performed by a user for a start frame of the first sub-segment, a start frame annotation result of the start frame may be obtained, and in response to an annotation request for an end frame of the first sub-segment, an end frame annotation result of the end frame may be generated, at the same time, in response to an annotation request for an intermediate frame(s) of the first sub-segment, an intermediate frame annotation result of the intermediate frame may be generated. The start frame annotation result is manually obtained by sampling, the annotation result of the end frame and the intermediate frame is automatically generated, manual annotation is reduced, and the annotation efficiency of the image frame is improved. In addition, through the annotation operation of the start frame, the annotation request of the end frame and the intermediate frame, the interaction annotation with the user is realized, and the effectiveness of annotation interaction is improved. According to the annotation result of respective image frame of the first sub-segment, the video annotation result of the video to be annotated may be displayed on the video annotation page, to implement visualization of the annotation process. According to the annotation method provided by the scheme, the annotation manner of the image is increased, the annotation difficulty of the image is effectively reduced, the annotation efficiency is improved, meanwhile, annotation visual interaction is provided, and the annotation effect and precision are improved.

In order to facilitate viewing respective image frame, different image frames may be displayed in different areas.

As shown in FIG. 3, FIG. 3 is a flowchart of still another embodiment of a method of video annotation according to an embodiment of the present disclosure.

301: display the start frame in a first image area of the video annotation page.

302: display the end frame in a second image area of the video annotation page.

303: display the intermediate frame in a third image area of the video annotation page, a number of intermediate frames displayed in the third image area being a predetermined image display number.

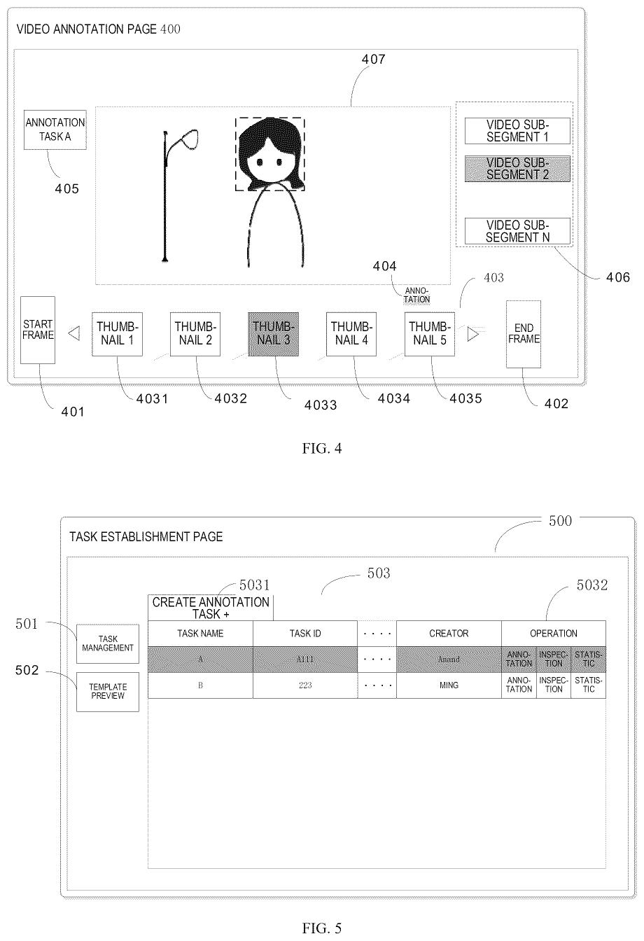

For ease of understanding, as shown in FIG. 4, the video annotation page 400 may include a first image area 401, a second image area 402, and a third image area 403. Wherein, the first image area 401 is configured to display a start frame, and the second image area 402 may display an end frame. The third image area 403 may be used to display at least one intermediate frame. The number of the at least one intermediate frame is a predetermined image display number of the third image area. For example, the third image area 403 may display several image display number.

For example, the image area may be, for example, an annotation prompt window of the image, and the annotation prompt window may display a thumbnail of the image. The video annotation page may display a thumbnail of the start frame in the first image area 401 at the lower right corner. The video annotation page may display a thumbnail of the end frame in the second image area 402 at the lower left corner. A third image area 403 located between the first image area 401 and the second image area 402 may be used to display a thumbnail of the intermediate frame.

The third image area 403 may include a plurality of image prompt windows, such as 4031-4035 shown in FIG. 4. Wherein, when any image prompt window is selected, for example, the image corresponding to the selected image prompt window 4033 may be used as an intermediate frame to be annotated, the intermediate frame may be an intermediate frame to be annotated, and not selected other image prompt window, for example, 4033 may be displayed differently from other display areas. When detecting the user selecting an intermediate frame and performing a triggering operation of the annotation control, it may be determined that the annotation request of the intermediate frame is detected. Of course, in practical applications, in order to realize efficient annotation of the image frame, the annotation request of the next intermediate frame may be directly initiated after the annotation of the intermediate frame ends and the annotation of the next intermediate frame is initiated.

Optionally, the annotation confirmation control 404 may be displayed on the video annotation page. If the image prompt window of a certain image is selected, the annotation confirmation control 404 may establish a confirmation association with the selected image prompt window, for example 4033 in the intermediate frame. The click operation performed by the user for the annotation confirmation control may be detected, and the intermediate frame corresponding to the image prompt window may be determined as the current intermediate frame to be annotated, and the annotation request of the current intermediate frame to be annotated may be generated, and the annotation of the intermediate frame may be performed in response to the annotation request. For example, an intermediate frame corresponding to the selected image prompt window 4033 may be displayed in the image display area or window 407. The annotation operation performed by the user for the annotation control of the image to be annotated may be detected, and the annotation operation of the image to be annotated may be initiated. For example, marking a face area in an image frame.

In this embodiment, the video annotation page may be displayed, and the start frame, the end frame, and the intermediate frame are prompted in a targeted manner through different image prompt areas in the video annotation page, so that the user can conveniently view the respective image frame, and the annotation prompt efficiency and prompt accuracy of the image to be annotated are improved.

In practical applications, the video to be annotated may include a plurality of videos to be annotated, and the same annotation video may have a need for a plurality of times of annotations, so that in order to facilitate the annotation management of the annotation video, the annotation task may be established for the video to be annotated, so as to perform annotation management for the respective video to be annotated.

For example, a task establishment page may be provided to implement the establishment and processing of the annotation task. Before determining the image to be annotated in the video to be annotated in response to the video annotation request, further comprises:
in response to a click operation performed on the task prompt control in the task establishment page, establishing an annotation task of the video to be annotated.

Displaying the task prompt information of the annotation task of the video to be annotated in the task display area of the task establishment page.

In response to a click operation performed by the user for the task prompt information of the video to be annotated, generating a video annotation request of the video to be annotated, and switching to the video annotation page of the video to be annotated.

The annotation task may refer to an annotation process established for the video to be annotated. The task establishment page may refer to a webpage used to implement a task of a program to be annotated, and may be obtained through a programming language such as HTML5, C ++, JAVA, or IOS and the like. The task establishment page may include a task display area. The task display area may be used to display task prompt information of an annotation task of respective video to be annotated.

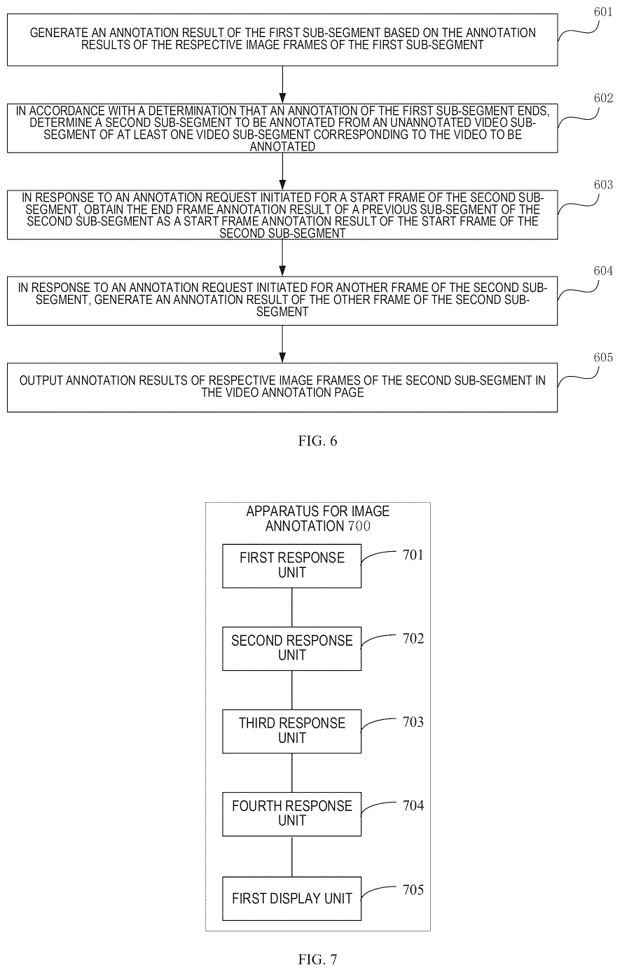

For ease of understanding, as shown in FIG. 5, an example diagram of one task establishment page 500. The task establishment page 500 may include a plurality of controls, such as a task management control 501, a template preview control 502. When the triggering of the task management control is detected, the task management sub-page 503 may be displayed. Wherein, the task management sub-page may include a task prompt control 5031 and a task display area 5032. Wherein, the control name of the task prompt control 5031 may prompt to establish a new annotation task. The task display area 5032 may display task information of the established annotation task. The task information may include: a task title, a task ID, a creation time, a creator, and a task operation control. In addition, the task information of the annotation task may further include other types of information, for example, information such as an annotation manner and a label type, and etc., which are not described herein again.

Wherein, one task may correspond to one piece of task information.

For example, after the user performs a click operation on a certain task prompt information A, a video annotation request of the video to be annotated is generated and switched to a video annotation page of the video to be annotated. Assuming that the video annotation page of the annotation task A corresponding to the task prompt information A may be shown in FIG. 4, the video annotation page 400 may include task prompt information 405 of the annotation task A: “annotation task A”. The task prompt information 405 may prompt the annotation task corresponding to the annotation task A. The video to be annotated corresponding to the annotation task A may be divided into a plurality of video sub-segments, and the video sub-segment 1-N may be displayed in the segment prompt area 406, for example, the video sub-segment 1-video sub-segment N shown in FIG. 4.

Optionally, establishing the annotation task of the video to be annotated may refer to a task execution module established for the video to be annotated, and the user may perform the annotation operation for the annotation task through a task operation control in the annotation task of the video to be annotated. For example, the task operation control may include: an annotation control, an inspection control, a statistic control, and the like. The annotation control may refer to an initiation prompt control of the annotation task of the video to be annotated, and the detecting the user triggering the annotation control may generate a video annotation request of the video to be annotated. The inspection control may refer to a prompt control for performing inspection on an annotation result generated by the annotation task of the video to be annotated, and detecting the user triggering the inspection control may initiate an inspection process of the annotation result of the respective image frame of the video to be annotated. The statistic control may refer to a control prompting annotation related data such as a number of times of annotation, a number of annotation and the like of the video to be annotated, and the detecting the user triggering statistic control may display various data generated by the annotation task of the video to be annotated.

Optionally, the task prompt control may include: a trigger control for creating an annotation task.

The target path may be a storage path of the video to be annotated selected by using the path. The video to be annotated may be uploaded to the annotation method through the target path to perform the annotation.

In this embodiment, the video upload page may be displayed on the upper layer of the task establishment page in response to a click operation performed for the task prompt control in the task establishment page. The video upload page may include a path selection control of the video storage path, and the task prompt control may be configured to prompt the newly created annotation task to obtain the target path in response to a path selection operation performed on the path selection control. The establishment of the annotation task of the video to be annotated is achieved through establishing the annotation task of the video to be annotated corresponding to the target path. The establishment of the annotation task of the video is completed through the path selection of the video, and the establishment efficiency and accuracy of the annotation task are improved.

For example, the first sub-segment may be a video sub-segment that needs to be annotated. The video sub-segment may sequentially annotate the remaining intermediate frames starting from the first image, that is, the annotation of the start frame and the end frame.

In practical applications, the third image area may be a sliding window. The method may further comprise:
in response to a click operation performed by the user on a first button on the left side of the sliding window, sliding the intermediate frames displayed in the third image area in a direction of the left side of the sliding window according to a sequence of the respective image frames, and updating the intermediate frames displayed in the third image area;
in response to the click operation performed by the user on a second button on the right side of the sliding window, sliding the intermediate frames displayed in the third image area in a direction of the right side of the sliding window according to the sequence of the respective image frames, and updating the intermediate frames displayed in the third image area.

As shown in FIG. 4, the third image area 403 may include a plurality of image prompt windows, such as 4031-4035 shown in FIG. 4, the value of the displayed image prompt number M may be, for example, 5, so 5 image prompt windows may be displayed in the window prompt area 401, and the thumbnail of the image frame may be displayed in each image prompt window to prompt the image frame. Starting from the second image frame of the target video sub-segment, 5 image frames are displayed in the third image area 403 according to the sequence of the respective image frames.

For example, in addition to the image prompt window, the third image area 403 may further include a first button and a second button. The first button and the second button may be triangular as shown in FIG. 4. In addition, the first button and the second button may be patterns of other shapes, for example, a circle, a rectangular and etc.

Displaying the M image frames in the window prompt area according to the sequence of the respective image frames may include: determining M image frames currently displayed; and sequentially displaying the M image frames in the window prompt area. The first unannotated image is determined from the M image frames as the image to be annotated.

In the embodiment of the present disclosure, when the third image area is a sliding window, the intermediate frame displayed in the third image may be sequentially slid to the left direction for display in response to a click operation performed by the user on the first button on the left side of the sliding window, further, in response to a click operation performed by the user on the second button on the right side of the sliding window, the intermediate frame displayed in the third image area is slid towards the right side direction of the sliding window according to the sequence of the respective image frames. Through clicking the window button, the update of the intermediate frame displayed in the sliding window by the user can be realized, the presented intermediate frame is continuously updated through the sliding manner of the left and right sides, and the effective presentation of the intermediate frame is realized.

In a possible design, the object to be annotated comprises one or more objects, the annotation results of the image frames of the first sub-segment comprise annotation sub-results respectively corresponding to a plurality of annotation objects.

In the embodiment of the present disclosure, one or more objects can be annotated in the image frame, multi-object annotation of one image frame is realized, and the annotation efficiency and accuracy are improved.

As shown in FIG. 6, FIG. 6 is a flowchart of another embodiment of a method of video annotation according to an embodiment of the present disclosure. What is different from the above mentioned embodiments is that, displaying a video annotation result of the video to be annotated in a video annotation page based on annotation results of respective image frames of the first sub-segment comprises:

601: generate an annotation result of the first sub-segment based on the annotation results of the respective image frames of the first sub-segment;

602: in accordance with a determination that an annotation of the first sub-segment ends, determine a second sub-segment to be annotated from an unannotated video sub-segment of at least one video sub-segment corresponding to the video to be annotated.

Optionally, the video to be annotated may be divided into at least one video sub-segment, and the target video sub-segment may be determined from the at least one video sub-segment in sequence according to a segment sequence respectively corresponding to the at least one video sub-segment.

The second sub-segment may be the second video sub-segment or a video sub-segment after the second video sub-segment.

Optionally, two adjacent video sub-segments may include a same video frame, and the image frame of a previous video sub-segment and a next video sub-segment may be set overlapped. In order to improve the video annotation efficiency, for two adjacent video sub-segments, the last image frame of the previous video sub-segment may be overlapped with the first image frame of the next video sub-segment. Therefore, the staring frame annotation result of the start frame of the segment can be obtained through the automatic annotation of the last image frame of the previous video sub-segment.

Optionally, the step of dividing the at least one video sub-segment may include: extracting a plurality of key frames of the video to be annotated, extracting the video to be annotated according to a plurality of key frames with an extraction policy of extracting one video sun-segment between two adjacent key frames to obtain at least one video sub-segment. Wherein, the last image frame of the previous video sub-segment of the two adjacent video sub-segments is the same as the first image frame of the next video sub-segment.

In a possible implementation, determining the second sub-segment to be annotated from the unannotated video sub-segment of the at least one video sub-segment may comprise: determining the second sub-segment to be annotated from the unannotated video sub-segment according to the segment dividing sequence of the at least one video sub-segment.

603: in response to an annotation request initiated for a start frame of the second sub-segment, obtain the end frame annotation result of a previous sub-segment of the second sub-segment as a start frame annotation result of the start frame of the second sub-segment.

The annotation result of the last image frame of the previous video sub-segment may be read to obtain the start frame annotation result of the start frame. By adopting the image frame overlapping sampling manner, the transmission of image annotation can be quickly realized, and the image annotation efficiency is improved.

604: in response to an annotation request initiated for another frame of the second sub-segment, generate an annotation result of the other frame of the second sub-segment.

Optionally, in response to an annotation request initiated for another frame of the second sub-segment, generate an annotation result of the other frame of the second sub-segment may comprise: in response to the annotation request for the end frame of the second sub-segment, generating an end frame annotation result of the end frame; and in response to the annotation request for the intermediate frame of the second sub-segment, generating an intermediate frame annotation result of the intermediate frame.

Optionally, may further comprise: in response to a modification operation performed by the user for the annotation result of the intermediate frame, obtaining a final annotation result of the intermediate frame. Updating the modified intermediate frame to be the start frame and the final annotation result to be the updated start frame annotation result, returning to execute the generation of the intermediate frame annotation result of the intermediate frame in response to the annotation request for the intermediate frame of the second sub-segment.

605: output annotation results of respective image frames of the second sub-segment in the video annotation page.

The output interface and content of the video annotation page of the second sub-segment may refer to the output of the first sub-segment, which is not described herein again.

In this embodiment of the present disclosure, the annotation result of the first sub-segment may be generated based on the annotation result of the respective image frame of the first sub-segment, and the second sub-segment to be annotated is determined from the unannotated video sub-segment of the at least one video sub-segment corresponding to the video to be annotated through the annotation result of the first sub-segment. The second sub-segment may be an unannotated video sub-segment. In response to the annotation request initiated for the start frame of the second subsegment, the end frame annotation result of the end frame of the previous video subsegment may be obtained as the start frame annotation result of the start frame of the second subsegment, so that the start frame is automatically obtained. For other frames, such as an end frame and an intermediate frame, annotation results of other frames may be generated. The second sub-segment annotated after the first sub-fragment may automatically obtain the annotation result from the start frame to the end frame, and does not need to be manually annotated, thereby achieving an efficient annotation of the video sub-segment. In addition, visual presentation of the annotation process may be implemented by outputting an annotation result of the respective image frame of the second sub-segment in the video annotation page.

In one embodiment, determining the second sub-segment to be annotated from the unannotated video sub-segment of the at least one video sub-segment corresponding to the video to be annotated comprises:
determining the at least one video sub-segment corresponding to the video to be annotated.
in response to a selection operation by the user for any of the at least one video sub-segment, obtaining a selected video sub-segment as the second sub-segment.

Optionally, the at least one video sub-segment may present the segment prompt information respectively. In response to a click operation triggered by the user for any one piece of segment prompt information, a second sub-segment corresponding to the segment prompt information clicked by the user is obtained. Selection of a video sub-segment may be achieved through a user trigger.

In the embodiments of the present disclosure, the selected video sub-segment may be obtained as the second sub-segment in response to a selection operation of the user for any video sub-segment. The user interaction response obtains the second sub-segment selected by the user, to achieve accurate selection of the second sub-segment.

As another embodiment, the method may further comprise:
presenting, in a segment prompt window of the video annotation page, respective segment prompt information corresponding to the at least one video sub-segment, the segment presentation window presenting the segment prompt information with a sub-window.

In order to prompt the at least one video sub-segment, segment prompt information corresponding to the at least one video sub-segment may be displayed in the video annotation page. For example, the segment prompt information of the several video sub-segments may be displayed in the segment prompt area 406 shown in FIG. 4, the segment prompt information may be, for example, prompted by using the segment name of the video sub-segment, the segment number of the at least one video sub-segment is the video sub-segment 1-N respectively, N is the segment number of the at least one video sub-segment, the segment name of the video sub-segment may be determined based on the division sequence of the video sub-segment, and the first video sub-segment extracted from the video to be annotated may be named as the video sub-segment 1. Of course, this naming manner is merely exemplary, which does not construct specific limitation on the naming manner of the segment. Wherein, the video sub-segment in the annotation state may be the target video sub-segment. Referring to FIG. 4, the video sub-segment 2 may be a target video sub-segment in an annotation state. The video sub-segment 2 in the annotation state may be in a selected state, and other video sub-segments, such as the video sub-segment 1, the video sub-segment 3—the video sub-segment N and etc., and other video sub-segments are all in an unselected state.

In the embodiments of the present disclosure, segment prompt information respectively corresponding to one video sub-segment may be displayed in a segment prompt window in the video annotation page, and the segment presentation window presents corresponding segment prompt information with the sub-window. Effective segment prompting can be carried out by presenting the segment prompt information, and the segment prompting efficiency and effectiveness are improved.

In some embodiments, after obtaining the start frame annotation result, further comprises:
displaying the start frame annotation result of the start frame in the result display area of the video annotation page.

After the end frame annotation result of the end frame is generated, further comprises:
switching the start frame annotation result displayed in the result display area to displaying the end frame annotation result of the end frame.

After the intermediate frame annotation result of the intermediate frame is generated, further comprises:
switching the end frame annotation result displayed in the result display area to displaying the intermediate frame annotation result of the intermediate frame.

In this embodiment, the result display area of the video annotation page is used to display the annotation result, and by sequentially displaying the annotation results of the start frame, the end frame, and the intermediate frame, the effective display of the annotation result may be achieved.

In a possible design, after generating the intermediate frame annotation result of the intermediate frame in response to the annotation request initiated for the intermediate frame of the first sub-segment, further comprises:
in response to a modification operation performed by the user for the annotation result of the intermediate frame, obtaining a final annotation result of the intermediate frame;
updating the modified intermediate frame to be the start frame and the final annotation result to be the updated start frame annotation result, returning to execute the generation of the intermediate frame annotation result of the intermediate frame in response to the annotation request for the intermediate frame of the first sub-segment.

Alternatively, in response to a confirmation operation performed by the user for the annotation result of the intermediate frame, determining that the annotation result of the intermediate frame is the final annotation result of the intermediate frame.

After the start frame is updated, the intermediate frame annotation result of the intermediate frame may be generated according to the end frame and the end frame annotation result in combination with the newly updated start frame and the start frame annotation result. The annotation result of the intermediate frame can be quickly and accurately generated by combining the annotation results of the new start frame and the end frame.

Optionally, after obtaining the final annotation result of the intermediate frame in response to the modification operation performed by the user for the annotation result of the intermediate frame, may further comprise: regenerating the end frame annotation result of the end frame according to the final annotation result of the intermediate frame. Generating an intermediate frame annotation result of the intermediate frame between the intermediate frame till the end frame according to the final annotation result of the intermediate frame.

Optionally, a result confirmation control set for the annotation result of the image to be annotated may be further displayed in the video annotation page; in response to the click operation triggered by the user for the result confirmation control, it may be determined that the annotation result currently corresponding to the currently annotated image frame is the final annotation result of the image frame.

Optionally, a result modification control set for the annotation result of the image to be annotated may be further displayed in the video annotation page; and in response to the click operation triggered by the user for the result modification control, the annotation modification operation performed by the user for the annotation result of the image to be annotated may be detected.

Wherein, the modification operation may include a modification operation performed on the annotation result of the annotation area, the label type, the annotation object position, and the like of the intermediate frame. For example, the update of the annotation area may obtain the updated area through operations such as erasing, dragging, and sliding. The updating of the label type may refer to deleting the original label of the annotation area, adding an area of a new label. The annotation modification result may include at least one of result of a label area modification result, a modification result of a label type, an update of the annotation object position, and the like. The user may manually modify the annotation result of the image to be annotated, to perform a second time modification annotation on the automatically generated annotation result, and improve the annotation precision.

In the embodiments of the present disclosure, the final annotation result of the intermediate frame may be obtained in response to a modification operation performed by the user for the annotation result of the intermediate frame. By interacting with the user, the intermediate frame can be revised in time, the revision effect of the user on the annotation result of the intermediate frame is achieved, and the annotation accuracy is improved. The annotation result of the intermediate frame may also be determined as the final annotation result of the intermediate frame in response to a confirmation operation performed by the user for the annotation result of the intermediate frame. By using the confirmation or modification operation of the annotation result of the intermediate frame by the user, the user can perform personalized monitoring on the annotation result of the intermediate frame, so that the final annotation result of the intermediate frame can be more matched with the user requirement, and the accuracy is higher.

In practical applications, inspection may be performed on the video annotation result of the video to be annotated. In another embodiment, the method may further comprise:
sending the video annotation result of the video to be annotated to an inspector.
receiving an annotation inspection result of the video to be annotated fed back by the inspector.
displaying the annotation inspection result of the video to be annotated.

Optionally, the inspector may include an electronic device corresponding to a user performing inspection on the video to be annotated. The inspector may obtain the annotation inspection result of the video to be annotated in response to the inspection operation performed by the user of the inspection for the video annotation result of the video to be annotated.

The video annotation result of the video to be annotated may include an annotation result corresponding to the respective image frame of the at least one video sub-segment, that is, the video annotation result may include an annotation result corresponding to the respective image frame in the video to be annotated.

The annotation inspection result may include an image frame with an annotation abnormality in the video annotation result. The inspector may detect an abnormal trigger operation performed by the user of the inspection for the image frame with the annotation abnormality, to obtain the image frame with the annotation abnormality. The annotation abnormality may include an existence of an error between an annotation result of the image frame and an annotation result required by the user.

In the embodiments of the present disclosure, the video annotation result of the video to be annotated may be sent to the inspector, to indicate the inspector to perform inspection on the video to be annotated. Through the inspection of the annotation result of the video to be annotated, the annotation effectiveness and reliability of the video to be annotated can be ensured.

FIG. 7 is a schematic structural diagram of an apparatus for image annotation according to an embodiment of the present disclosure. The apparatus for image annotation 700 may include the following units:
a first response unit 701, configured to determine, in response to a video annotation request, a first sub-segment among sub-segments to be annotated in a video to be annotated.
a second response unit 702, configured to obtain, in response to an annotation operation performed by a user for a start frame of the first sub-segment, a start frame annotation result of the start frame.
a third response unit 703, configured to generate, in response to an annotation request for an end frame of the first sub-segment, an end frame annotation result of the end frame.
a fourth response unit 704, configured to generate, in response to the annotation request for an intermediate frame(s) of the first sub-segment, an intermediate frame annotation result of the intermediate frame.
a first display unit 705, configured to display a video annotation result of the video to be annotated in a video annotation page based on annotation results of respective image frames of the first sub-segment.

In one embodiment, the apparatus may comprise:
a second display unit, configured to display the start frame in a first image area of the video annotation page;
a third display unit, configured to display the end frame in a second image area of the video annotation page;
a fourth display unit, configured to display the intermediate frame in a third image area of the video annotation page, a number of intermediate frames displayed in the third image area being a predetermined image display number.

In another embodiment, the third image area is a sliding window; further comprising:
a first response module, configured to, in response to a click operation performed by the user on a first button on the left side of the sliding window, slide the intermediate frames displayed in the third image area in a direction of the left side of the sliding window according to a sequence of the respective image frames, and updating the intermediate frames displayed in the third image area;
a second response module, configured to, in response to the click operation performed by the user on a second button on the right side of the sliding window, slide the intermediate frames displayed in the third image area in a direction of the right side of the sliding window according to the sequence of the respective image frames, and updating the intermediate frames displayed in the third image area.

In some embodiments, the object to be annotated comprises one or more objects, the annotation results of the image frames of the first sub-segment comprise annotation sub-results respectively corresponding to a plurality of annotation objects.

In some embodiments, the first display unit may comprise:
a result generating module, configured to generate an annotation result of the first sub-segment based on the annotation results of the respective image frames of the first sub-segment;
a segment determining module, configured to, in accordance with a determination that an annotation of the first sub-segment ends, determine a second sub-segment to be annotated from an unannotated video sub-segment of at least one video sub-segment corresponding to the video to be annotated;
a segment annotation module, configured to, in response to an annotation request initiated for a start frame of the second sub-segment, obtain the end frame annotation result of a previous sub-segment of the second sub-segment as a start frame annotation result of the start frame of the second sub-segment;
a result generating module, configured to in response to an annotation request initiated for another frame of the second sub-segment, generate an annotation result of the other frame of the second sub-segment.

A result display module is configured to output annotation results of respective image frames of the second sub-segment in the video annotation page.

In some embodiments, the segment determining module comprises:
a video segment sub-module, configured to determine the at least one video sub-segment corresponding to the video to be annotated.
a segment selection sub-module, configured to, in response to a selection operation by the user for any of the at least one video sub-segment, obtain a selected video sub-segment as the second sub-segment.

In another embodiment, further comprising:
a segment prompt unit, configured to present, in a segment prompt window of the video annotation page, respective segment prompt information corresponding to the at least one video sub-segment, the segment presentation window presenting the segment prompt information with a sub-window.

In one embodiment, further comprising:
a result modification unit, configured to, in response to a modification operation performed by the user for the annotation result of the intermediate frame, obtain a final annotation result of the intermediate frame;
a start frame updating unit, configured to update the modified intermediate frame to be the start frame and the final annotation result to be the updated start frame annotation result, returning to execute the generation of the intermediate frame annotation result of the intermediate frame in response to the annotation request for the intermediate frame of the first sub-segment.

Alternatively, the annotation confirmation unit is configured to, in response to a confirmation operation performed by the user for the annotation result of the intermediate frame, determine that the annotation result of the intermediate frame is the final annotation result of the intermediate frame.

In another embodiment, further comprises:
a result sending unit, configured to send the video annotation result of the video to be annotated to an inspector;
an inspection receiving unit, configured to receive an annotation inspection result of the video to be annotated fed back by the inspector;
the inspection display unit is configured to display the annotation inspection result of the video to be annotated.

The apparatus provided in this embodiment may be configured to perform the technical solutions in the foregoing method embodiments, and implementation principles and technical effects thereof are similar, which are not described herein again in this embodiment.

In order to achieve the above embodiments, an embodiment of the present disclosure further provides an electronic device.

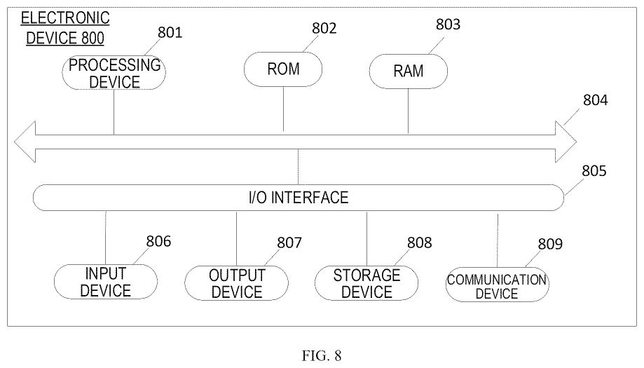

FIG. 8 shows a schematic structural diagram of an electronic device 800 suitable for implementing embodiments of the present disclosure, and the electronic device 800 may be a terminal device or a server. The terminal device may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 8 is merely an example, and should not impose any limitation on the functions and scope of use of the embodiments of the present disclosure.

As shown in FIG. 8, the electronic device 800 may include a processing device (for example, a central processing unit, a graphics processor, etc.) 801, which may perform various appropriate actions and processing according to a program stored in a read only memory (ROM) 802 or a program loaded into a random access memory (RAM) 803 from a storage device 808. In the RAM 803, various programs and data required by the operation of the electronic device 800 are also stored. The processing device 801, the ROM 802, and the RAM 803 are connected to each other through a bus 804. Input/output (I/O) interface 805 is also connected to bus 804.

Generally, the following devices may be connected to the I/O interface 805: an input device 806 including, for example, a touch screen, a touch pad, a keyboard, a mouse, a camera, a microphone, an accelerometer, a gyroscope, etc. ; an output device 807 including, for example, a liquid crystal display (LCD), a speaker, a vibrator, etc.; a storage device 88 including, for example, a magnetic tape, a hard disk, etc.; and a communication device 809. The communication device 809 may allow the electronic device 800 to communicate wirelessly or wired with other devices to exchange data. While FIG. 7 shows an electronic device 800 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a computer readable medium, the computer program comprising program code for performing the method shown in the flowchart. In such embodiments, the computer program may be downloaded and installed from the network through the communication device 809, or installed from the storage device 808, or from the ROM 802. When the computer program is executed by the processing device 801, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, including object oriented programming languages, such as Java, Smalltalk, C ++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “obtaining at least two units of Internet Protocol addresses”.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to a first aspect, a method of video annotation is provided according to one or more embodiments of the present disclosure, comprising:
in response to a video annotation request, determining a first sub-segment among sub-segments to be annotated in a video to be annotated;
in response to an annotation operation performed by a user for a start frame of the first sub-segment, obtaining a start frame annotation result of the start frame;
in response to an annotation request for an end frame of the first sub-segment, generating an end frame annotation result of the end frame;
in response to an annotation request for an intermediate frame(s) of the first sub-segment, generating an intermediate frame annotation result of the intermediate frame;
displaying a video annotation result of the video to be annotated in a video annotation page based on annotation results of respective image frames of the first sub-segment.

According to one or more embodiments of the present disclosure, further comprises:
displaying the start frame in a first image area of the video annotation page;
displaying the end frame in a second image area of the video annotation page;
displaying the intermediate frame in a third image area of the video annotation page, a number of intermediate frames displayed in the third image area being a predetermined image display number.

According to one or more embodiments of the present disclosure, the third image area is a sliding window; further comprising:
in response to a click operation performed by the user on a first button on the left side of the sliding window, sliding the intermediate frames displayed in the third image area in a direction of the left side of the sliding window according to a sequence of the respective image frames, and updating the intermediate frames displayed in the third image area;
in response to the click operation performed by the user on a second button on the right side of the sliding window, sliding the intermediate frames displayed in the third image area in a direction of the right side of the sliding window according to the sequence of the respective image frames, and updating the intermediate frames displayed in the third image area.

According to one or more embodiments of the present disclosure, the object to be annotated comprises one or more objects, the annotation results of the image frames of the first sub-segment comprise annotation sub-results respectively corresponding to a plurality of annotation objects.

According to one or more embodiments of the present disclosure, displaying the video annotation result of the video to be annotated in the video annotation page based on annotation results of the respective image frames of the first sub-segment comprises:
generating an annotation result of the first sub-segment based on the annotation results of the respective image frames of the first sub-segment;
in accordance with a determination that an annotation of the first sub-segment ends, determining a second sub-segment to be annotated from an unannotated video sub-segment of at least one video sub-segment corresponding to the video to be annotated;
in response to an annotation request initiated for a start frame of the second sub-segment, obtaining the end frame annotation result of a previous sub-segment of the second sub-segment as a start frame annotation result of the start frame of the second sub-segment;
in response to an annotation request initiated for another frame of the second sub-segment, generating an annotation result of the other frame of the second sub-segment.
outputting annotation results of respective image frames of the second sub-segment in the video annotation page.

According to one or more embodiments of the present disclosure, determining the second sub-segment to be annotated from the unannotated video sub-segment of the at least one video sub-segment corresponding to the video to be annotated comprises:
determining the at least one video sub-segment corresponding to the video to be annotated.
in response to a selection operation by the user for any of the at least one video sub-segment, obtaining a selected video sub-segment as the second sub-segment.

According to one or more embodiments of the present disclosure, further comprises:
presenting, in a segment prompt window of the video annotation page, respective segment prompt information corresponding to the at least one video sub-segment, the segment presentation window presenting the segment prompt information with a sub-window.

According to one or more embodiments of the present disclosure, after generating the intermediate frame annotation result of the intermediate frame in response to the annotation request for the intermediate frame of the first sub-segment, further comprising:
in response to a modification operation performed by the user for the annotation result of the intermediate frame, obtaining a final annotation result of the intermediate frame;
displaying a final annotation result of the intermediate frame in the result display area;

Alternatively, in response to a confirmation operation performed by the user for the annotation result of the intermediate frame, determining that the annotation result of the intermediate frame is the final annotation result of the intermediate frame.

According to one or more embodiments of the present disclosure, further comprising:
sending the video annotation result of the video to be annotated to an inspector;
receiving an annotation inspection result of the video to be annotated fed back by the inspector;
displaying the annotation inspection result of the video to be annotated.

According to a second aspect, an apparatus for video annotation is provided according to one or more embodiments of the present disclosure, comprising:
a first response unit, configured to determine, in response to a video annotation request, a first sub-segment among sub-segments to be annotated in a video to be annotated;
a second response unit, configured to obtain, in response to an annotation operation performed by a user for a start frame of the first sub-segment, a start frame annotation result of the start frame;
a third response unit, configured to generate, in response to an annotation request for an end frame of the first sub-segment, an end frame annotation result of the end frame;
a fourth response unit, configured to generate, in response to the annotation request for an intermediate frame(s) of the first sub-segment, an intermediate frame annotation result of the intermediate frame;
a first display unit, configured to display a video annotation result of the video to be annotated in a video annotation page based on annotation results of respective image frames of the first sub-segment.

According to a third aspect, an electronic device is provided according to one or more embodiments of the present disclosure, comprising: at least one processor and a memory;
a memory storing computer-executable instructions;
the at least one processor executes the computer-executable instructions stored in the memory, so that the at least one processor executes the method of video annotation according to the first aspect and various possible designs of the first aspect.

According to a fourth aspect, a computer-readable storage medium is provided according to one or more embodiments of the present disclosure, where the computer-readable storage medium stores computer-executable instructions, and when the processor executes the computer-executable instruction, the method of video annotation according to the first aspect and the possible designs of the first aspect is implemented.

According to a fifth aspect, a computer program product is provided according to one or more embodiments of the present disclosure, comprising a computer program, where when the computer program is executed by a processor, the method of video annotation according to the first aspect and various possible designs of the first aspect is implemented.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation which are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method of video annotation, comprising:
in response to a video annotation request, determining a first sub-segment among sub-segments to be annotated in a video to be annotated;
in response to an annotation operation performed by a user for a start frame of the first sub-segment, obtaining a start frame annotation result of the start frame;
in response to an annotation request for an end frame of the first sub-segment, generating an end frame annotation result of the end frame;
in response to an annotation request for at least one intermediate frame of the first sub-segment, generating an intermediate frame annotation result of the at least one intermediate frame; and
displaying a video annotation result of the video to be annotated in a video annotation page based on the annotation results of respective image frames of the first sub-segment.

2. The method according to claim 1, further comprising:
displaying the start frame in a first image area of the video annotation page;
displaying the end frame in a second image area of the video annotation page; and
displaying the at least one intermediate frame in a third image area of the video annotation page, the number of at least one intermediate frame displayed in the third image area being a predetermined image display number.

3. The method according to claim 2, wherein the third image area is a sliding window; further comprising:
in response to a click operation performed by the user on a first button on the left side of the sliding window, sliding the at least one intermediate frame displayed in the third image area in a direction of the left side of the sliding window according to a sequence of the respective image frames, and updating the at least one intermediate frame displayed in the third image area; and
in response to the click operation performed by the user on a second button on the right side of the sliding window, sliding the at least one intermediate frame displayed in the third image area in a direction of the right side of the sliding window according to the sequence of the respective image frames, and updating the at least one intermediate frame displayed in the third image area.

4. The method according to claim 1, wherein the object to be annotated comprises one or more objects, the annotation results of the image frames of the first sub-segment comprise annotation sub-results respectively corresponding to a plurality of annotation objects.

5. The method according to claim 1, wherein displaying the video annotation result of the video to be annotated in the video annotation page based on annotation results of the respective image frames of the first sub-segment comprises:
generating an annotation result of the first sub-segment based on the annotation results of the respective image frames of the first sub-segment;
in accordance with a determination that an annotation of the first sub-segment ends, determining a second sub-segment to be annotated from an unannotated video sub-segment of at least one video sub-segment corresponding to the video to be annotated;
in response to an annotation request initiated for a start frame of the second sub-segment, obtaining the end frame annotation result of a previous sub-segment of the second sub-segment as a start frame annotation result of the start frame of the second sub-segment;
in response to an annotation request initiated for another frame of the second sub-segment, generating an annotation result of the other frame of the second sub-segment; and
outputting annotation results of respective image frames of the second sub-segment in the video annotation page.

6. The method according to claim 5, wherein determining the second sub-segment to be annotated from the unannotated video sub-segment of the at least one video sub-segment corresponding to the video to be annotated comprises:
determining the at least one video sub-segment corresponding to the video to be annotated; and
in response to a selection operation by the user for any of the at least one video sub-segment, obtaining a selected video sub-segment as the second sub-segment.

7. The method according to claim 5, further comprising:
presenting, in a segment prompt window of the video annotation page, respective segment prompt information corresponding to the at least one video sub-segment, the segment prompt window presenting the segment prompt information with a sub-window.

8. The method according to claim 1, after generating the intermediate frame annotation result of the intermediate frame in response to the annotation request for the intermediate frame of the first sub-segment, further comprising:
in response to a modification operation performed by the user for the annotation result of an intermediate frame of the at least one intermediate frame, obtaining a final annotation result of the intermediate frame;
updating the modified intermediate frame as the start frame and updating the final annotation result as the updated start frame annotation result, returning to execute the generation of the intermediate frame annotation result of the at least one intermediate frame in response to the annotation request for the at least one intermediate frame of the first sub-segment; or
in response to a confirmation operation performed by the user for the annotation result of an intermediate frame of the at least one intermediate frames, determining that the annotation result of the intermediate frame is the final annotation result of the intermediate frame.

9. The method according to claim 1, further comprising:
sending the video annotation result of the video to be annotated to an inspector;
receiving an annotation inspection result of the video to be annotated fed back by the inspector; and
displaying the annotation inspection result of the video to be annotated.

10-13. (canceled)

14. An electronic device, comprising: a processor, a memory, and an output device;
the memory storing computer-executable instructions;
the processor executes the computer-executable instructions stored in the memory, such that the processor is configured with a method of video annotation, and the output device is configured to output the video annotation page, wherein the method of video annotation comprises:
in response to a video annotation request, determining a first sub-segment among sub-segments to be annotated in a video to be annotated;
in response to an annotation operation performed by a user for a start frame of the first sub-segment, obtaining a start frame annotation result of the start frame;
in response to an annotation request for an end frame of the first sub-segment, generating an end frame annotation result of the end frame;
in response to an annotation request for at least one intermediate frame of the first sub-segment, generating an intermediate frame annotation result of the at least one intermediate frame; and
displaying a video annotation result of the video to be annotated in a video annotation page based on the annotation results of respective image frames of the first sub-segment.

15. The electronic device of claim 14, wherein the method further comprises:
displaying the start frame in a first image area of the video annotation page;
displaying the end frame in a second image area of the video annotation page; and
displaying the at least one intermediate frame in a third image area of the video annotation page, the number of the at least one intermediate frame displayed in the third image area being a predetermined image display number.

16. The electronic device of claim 15, wherein the third image area is a sliding window; further comprising:
in response to a click operation performed by the user on a first button on the left side of the sliding window, sliding the at least one intermediate frame displayed in the third image area in a direction of the left side of the sliding window according to a sequence of the respective image frames, and updating the at least one intermediate frame displayed in the third image area; and
in response to the click operation performed by the user on a second button on the right side of the sliding window, sliding the at least one intermediate frame displayed in the third image area in a direction of the right side of the sliding window according to the sequence of the respective image frames, and updating the at least one intermediate frame displayed in the third image area.

17. The electronic device of claim 14, wherein the object to be annotated comprises one or more objects, the annotation results of the image frames of the first sub-segment comprise annotation sub-results respectively corresponding to a plurality of annotation objects.

18. The electronic device of claim 14, wherein displaying the video annotation result of the video to be annotated in the video annotation page based on annotation results of the respective image frames of the first sub-segment comprises:
generating an annotation result of the first sub-segment based on the annotation results of the respective image frames of the first sub-segment;
in accordance with a determination that an annotation of the first sub-segment ends, determining a second sub-segment to be annotated from an unannotated video sub-segment of at least one video sub-segment corresponding to the video to be annotated;
in response to an annotation request initiated for a start frame of the second sub-segment, obtaining the end frame annotation result of a previous sub-segment of the second sub-segment as a start frame annotation result of the start frame of the second sub-segment;
in response to an annotation request initiated for another frame of the second sub-segment, generating an annotation result of the other frame of the second sub-segment; and
outputting annotation results of respective image frames of the second sub-segment in the video annotation page.

19. The electronic device of claim 18, wherein determining the second sub-segment to be annotated from the unannotated video sub-segment of the at least one video sub-segment corresponding to the video to be annotated comprises:
determining the at least one video sub-segment corresponding to the video to be annotated; and
in response to a selection operation by the user for any of the at least one video sub-segment, obtaining a selected video sub-segment as the second sub-segment.

20. The electronic device of claim 18, wherein the method further comprises:
presenting, in a segment prompt window of the video annotation page, respective segment prompt information corresponding to the at least one video sub-segment, the segment prompt window presenting the segment prompt information with a sub-window.

21. The electronic device of claim 14, after generating the intermediate frame annotation result of the intermediate frame in response to the annotation request for the intermediate frame of the first sub-segment, further comprising:
in response to a modification operation performed by the user for the annotation result of an intermediate frame of the at least one intermediate frame, obtaining a final annotation result of the intermediate frame;
updating the modified intermediate frame as the start frame and updating the final annotation result as the updated start frame annotation result, returning to execute the generation of the intermediate frame annotation result of the at least one intermediate frame in response to the annotation request for the at least one intermediate frame of the first sub-segment; or
in response to a confirmation operation performed by the user for the annotation result of an intermediate frame of the at least one intermediate frames, determining that the annotation result of the intermediate frame is the final annotation result of the intermediate frame.

22. The electronic device of claim 14, wherein the method further comprises:
sending the video annotation result of the video to be annotated to an inspector;
receiving an annotation inspection result of the video to be annotated fed back by the inspector; and
displaying the annotation inspection result of the video to be annotated.

23. A non-transitory computer-readable storage medium, wherein the computer-readable storage medium stores computer-executable instructions, the computer-executable instructions, when executed by a processor, implement a method of video annotation comprising:
in response to a video annotation request, determining a first sub-segment among sub-segments to be annotated in a video to be annotated;
in response to an annotation operation performed by a user for a start frame of the first sub-segment, obtaining a start frame annotation result of the start frame;
in response to an annotation request for an end frame of the first sub-segment, generating an end frame annotation result of the end frame;
in response to an annotation request for at least one intermediate frame of the first sub-segment, generating an intermediate frame annotation result of the at least one intermediate frame; and
displaying a video annotation result of the video to be annotated in a video annotation page based on the annotation results of respective image frames of the first sub-segment.

24. The non-transitory computer-readable storage medium of claim 23, wherein the method further comprises:
displaying the start frame in a first image area of the video annotation page;
displaying the end frame in a second image area of the video annotation page; and
displaying the at least one intermediate frame in a third image area of the video annotation page, the number of the at least one intermediate frame displayed in the third image area being a predetermined image display number.
